(19) United States
(12) Patent Application Publication
(10) Pub. No.: US 2008/0126194 A1
(43) Pub. Date: May 29, 2008

(54) Methods for advertising in airport and/or seaport security areas

(75) Inventors: Kirk Robert Adams, Smyrna, GA (US); Allison Thomas Johnson, Jonesboro, GA (US)

Correspondence Address: Locke Lord Bissell & Liddell LLP, 111 S. Wacker Drive, Chicago, IL, 60606-4410, US

(73) Assignee: The Adason Group, LLC

(21) Appl. No.: 11/606,264

(22) Filed: Nov. 28, 2006

(51) Int. Cl. G06Q 30/00

(52) U.S. Cl. 705/14

(57) ABSTRACT

The present invention provides methods for advertising in airport and/or seaport security areas, wherein advertising revenue that is generated by advertising fees that are collected by a security container distributor from an advertiser as a result of a sale of one or more advertisements is shared by the security container distributor with an airport and/or seaport in a revenue sharing arrangement. This method is extremely beneficial financially to the airport and/or seaport, which generally has no financial obligations(s) in connection with either the security container distributor or an advertiser, and yet receives from the security container distributor both: (a) one or more airport security containers that may be used by the airport and/or seaport in an airport and/or seaport security area free of charge; and (b) in a revenue sharing program between the security container distributor and the airport and/or seaport, revenue resulting from the sales of the one or more advertisements.

### BACKGROUND OF THE INVENTION

1. Field of the Invention

The present invention relates to methods for advertising in airport and/or seaport security areas, wherein revenue that is generated by, or results from, advertising sales fees that are collected by a security container distributor from an advertiser as a result of a sale of one or more advertisements is shared by the security container distributor with an airport and/or seaport in a revenue sharing arrangement. These methods are extremely beneficial financially to the airport and/or seaport, which have no initial or other investment (no financial obligations(s) in connection with either the security container distributor or the advertiser), and yet receive from the security container distributor both: (a) one or more airport and/or seaport security containers that may be used by the airport and/or seaport in an airport and/or seaport security area (free of charge); and (b) in a revenue sharing arrangement between the security container distributor and the airport and/or seaport, a share of the revenue resulting from the sales of the one or more advertisements. These methods advantageously include a value-based revenue share program, preferably with no out-of-pocket costs to an airport and/or seaport, and may additionally include corresponding customer services, including partial or total operational oversight, operational support, quality control and assurance, and maintenance programs.

2. Background

Containers of Liquids and Security Bags

The Transportation Security Administration (“TSA”) is currently comprised of approximately forty three thousand security officers, inspectors, directors, air marshals and managers who function to protect the United States' transportations systems so that travelers may travel in a safe manner. It generally screens travelers at airports and/or seaports, inspects rail cars, patrols subways with law enforcement partners, and attempts to prevent terrorists from causing harm to individuals and/or property in the United States.

In recent years, security screening for travelers at airports and seaports has increased substantially. Every security checkpoint has imposed increasingly stringent and expensive procedures, ultimately increasing costs to airport and seaport authorities, and to their passengers.

On Aug. 10, 2006, the Department of Homeland Security and the TSA imposed a total ban of carry-on liquids in airplanes as a result of police in London uncovering a plot to blow up passenger jets with liquid explosives. This complete ban of all liquids upset air travel significantly, adversely affecting airlines as more of their potential customers opted to drive, rather than fly, to various destinations. Additionally, the volume of checked baggage increased substantially, and airplane trips took more time, as airplane travelers waited at luggage carousels.

On Sep. 26, 2006, the total ban of carry on liquids in airplanes was relaxed by the Department of Homeland Security and the TSA in favor of other new airport safety rules and regulations governing carry-on liquids on airplanes. As a result of the new airport safety rules and regulations, only containers that can hold no more than three ounces of a liquid or semi-liquid substance or material, such as toothpaste, mouth wash, hand lotion, liquid soap, hand sanitizer, shampoo, cream rinse, other hair care products, shaving cream and/or other personal care products, are permitted to be carried on board of an airplane by passengers, for example, on their person or in carry-on luggage or purses. Further, all such products must be visible when passing through any security checkpoint. Containers that can hold more than three ounces of a substance or material, such as many water and other beverage bottles, and large containers of toothpaste, mouth wash, hand lotion, liquid soap, hand sanitizer, shampoo, cream rinse and other hair care products, are no longer permitted to be carried onto an airplane. Such containers are believed to potentially pose a security threat to human beings, airports and/or aircrafts in that they can provide a vehicle for mixing enough liquid explosives to create a bomb. Airport security screeners now confiscate any nonconforming items, or send travelers to ticket counters to place non-conforming containers into their checked luggage.

Also, as a result of the new airport safety rules and regulations, airplane travelers are now required to place containers that can hold three ounces or less of a liquid or semi-liquid substance or material into one quart size, zip-top, plastic security bag. Gallon sized bags, fold-over bags, and multiple bags are typically not permitted. Even if an airline passenger only has one three-ounce or smaller bottle to carry onto an airplane, it must be carried in a quart-size, zip-top bag.

The new airport safety rules and regulations are the result of specific core security issues. Three ounce bottles make it extremely difficult to handle and mix liquid explosives, and the one quart-size bag limits the total volume of liquids that an airline passenger can bring aboard an airplane without creating too much of a bottleneck in airport security areas.

In order to reduce the frustration and/or confusion expressed by some airline travelers about the new airport safety rules and regulations, upon request, some airlines, such as Continental and Southwest Airlines, now provide quart-size, zip-top, plastic bags to their customers at ticket counters. However, many other airlines, such as American, UAL Corp.'s United Airlines, Delta Air Lines Inc., Northwest Airlines Inc., JetBlue Airways Corp. and Frontier apparently do not provide such bags to their customers. Many local airport managers around the United States, however, are also moving in the direction of supplying these bags to their customers. This, however, often adds a tremendous financial burden of many thousands of dollars each month to airports and/or seaports, such as cruise lines, which must purchase these bags before providing them to their passengers. In an effort to improve security checkpoint efficiency, many airports have begun to provide the bags to passengers, taking this financial burden on themselves.

Security Bins

As airline and seaport security has intensified, security bins have become commonly encountered items for air and sea travelers in airport and seaport security areas. Generally rectangular in shape with four upwardly extending walls, such security bins may be used to hold laptop computers, purses, wallets, keys, jewelry, cameras, video equipment, shoes, coats and other personal items as the security bins typically travel on a conveyor belt that passes through a security X-ray device, metal detector or other security screening device.

Advertising

Advertising is an integral component of modem commerce. The goal of advertisers is generally to deliver one or more messages to a large group of consumers in a manner that: (a) the attention of the consumers can be captured; and (b) the advertising activity does not present an annoyance to the consumers.

Disadvantageously, typical billboard advertising generally allows an advertiser with only about three to four seconds to educate, and communicate with, consumers. In contrast, security bags and security bins are both viewed and handled by substantial numbers of airplane and/or seaport travelers, as well as airport and/or seaport personnel, all of whom are consumers and potential customers of advertised products, periodically throughout the course of a day on a daily basis. Many of these airplane and/or seaport travelers may be “on-the-go” type business and/or leisure travelers who are hard to reach by advertisers, and affluent (i.e., they have funds that may be required to purchase advertised goods and/or services).

Revenue

In an ever-fluctuating economy, airports, seaports and other businesses make a continuous and concerted effort to improve revenue. Those businesses that are in various fields of the travel industry, such as airports and seaports, continue to search for revenue generating opportunities that will positively impact their bottom line, with little or no cost to them.

It would be beneficial to provide methods for advertising in airport and seaport security areas, wherein advertising revenue that is generated by advertising fees that are collected by a security container distributor from an advertiser as a result of a sale of one or more advertisements is shared by the security container distributor with an airport or seaport.

### SUMMARY OF THE INVENTION

The present invention provides methods for advertising in a security area and/or security checkpoint located in, outside of, or near an airport and/or seaport wherein a percentage of gross or net revenue generated by, or otherwise resulting from, advertising sales fees that are collected by a security container distributor from an advertiser as a result of a sale of one or more advertisements is shared by the security container distributor with the airport and/or seaport. Such methods advantageously includes a turnkey or other type of a revenue share program, which may include revenue sharing, gifting and/or bartering, that beneficially can substantially reduce operational costs to airports and/or seaports.

The methods of the invention comprise:
(a) providing by the security container distributor to the airport and/or seaport free of charge, or with no substantial investment, one or more security containers, wherein the security containers have an ability to contain one or more personal items of a traveler that enters into the security area, wherein the security containers are one or more security bins, security bags or a combination of security bins and security bags, and wherein the security containers have one or more surfaces to which one or more advertisements may be affixed in a manner that the advertisements can be partially or fully viewed by the public and/or personnel of the airport and/or seaport when located in the security area;
(b) collecting by the security container distributor from the advertiser of one or more advertisement sales fees in exchange or consideration for one or more opportunities by the advertiser to have one or more advertisements affixed to one or more of the surfaces of the security containers;
(c) affixing the advertisements to the surfaces of the security containers at one or more locations and in a manner that the advertisements are visible to the public and/or personnel of the airport and/or seaport when located in the security area;
(d) placing the security containers in one or more security areas of the airport and/or seaport in a manner that the security containers are visible to the public and/or personnel of the airport or seaport when located in the security area; and
(e) sharing by the security container distributor with the airport and/or seaport of a percentage of all gross or net revenue generated by, or resulting from, the advertisement sales fees.

### BRIEF DESCRIPTION OF THE DRAWINGS

FIG. 1 is a perspective view of a security bin that may be employed in the methods of the invention, which has an advertisement affixed to an exterior surface of one of its walls and to the interior surface of its base.

FIG. 2 is a front view of the security bin that is shown in FIG. 1.

FIG. 3 is a front view of six of the security bins that are shown in FIG. 1 in a stacked configuration.

FIG. 4 is a perspective view of a security bag that may be employed in the methods of the invention, which has an advertisement affixed to an exterior surface on its front.

FIG. 5 is a front view of the security bin that is shown in FIG. 4.

### DETAILED DESCRIPTION OF THE PREFERRED EMBODIMENTS

The present invention may be understood more readily by reference to the following detailed description of the preferred embodiments of the invention, and to the example included therein.

### DEFINITIONS

For purposes of clarity, various terms and phrases used throughout this specification and the appended claims are defined in the manner set forth below. If a term or phrase used in this specification, or in the appended claims, is not defined below, or otherwise in this specification, the term or phrase should be given its ordinary meaning.

The term “advertiser” as used herein means an individual, corporation, partnership or other entity that advertises, or seeks to advertise, one or more advertisements to the public, for example, in an airport or seaport, or its agent, representative or other designee.

The phrases “advertising material”, “ad” or “advertisement” as used herein mean any type of a notice or advertisement that is designed to attract public attention and/or patronage, for example, for products, goods and/or services, whether in written form (typed letters, printed letters, script, etc.) and/or graphic form (drawings and the like).

The term “affix” as used herein means to permanently or removably attach or imbed one material, such as an advertisement, onto or into another material, such as a surface of a security bin or a security bag, using conventional methods that are known by those of skill in the art, such as gluing, stapling, taping, heat sealing, imprinting, sublimation, silk-screening, inserting into some type of a holder, or the like, or other desired methods. Those of skill in the art know a wide variety of methods that may be employed to affix one or more advertisements to an object, such as a security container.

The term “airport” as used herein means a place or facility where an aircraft (commercial airplane, private airplane, jet, rocket and/or the like) can take off and/or land, or an aircraft, and may include one or more owners of an airport, airlines, aircrafts and/or governing airport authorities, for example, in the case in which an airport is owned by one or more separate entities, or the Transportation Security Administration (TSA).

The phrase “airport security area” as used herein means a security area and/or security checkpoint in, near or in connection with an airport, such as an airport security terminal, where a person and/or his or her personal items are screened, searched and/or otherwise checked by human beings and/or x-ray, scanning, metal detecting, particulate matter sensing and/or other machines prior to permitting the person and/or his or her personal items to leave that area of the airport and/or enter another area of the airport. Typically, a person travels through a metal detector area and removes various items from his or her pockets and places the personal items in a bin that travels along a conveyer belt to be hand checked and/or machine checked.

The term “bartering” as used herein means a system of trading goods and/or services for something else, or some other item, of value, such as advertising time and/or space. For example, a security container company could trade out the value of one or more goods and/or services (generally other than money) to an airport in return for the same value in advertising space and/or time. Likewise, and advertiser could trade out the value of one or more goods and/or services (generally other than money) to a security container distributor in return for the same value in advertising space and/or time. The goods and/or services that may be exchanged may be any type of good and/or service, which are known by those of skill in the art.

The terms “bottom” and “base” as used herein in connection with a security bin means the portion of the bin that rests upon another structure, which is generally horizontal, such as a table, conveyer belt, floor or similar structure. It generally has an “upper” surface (the surface upon which items are placed, and faces towards the ceiling) and a “lower” surface (the surface that contacts the table, conveyer belt or similar structure).

The term “consumer” as used herein means an individual or entity, such as a business or household, that purchases and/or uses goods and/or services generated within the economy.

The phrase “consumer impression time” as used herein means an amount of time that an advertiser may have to make some type of an impression on a consumer with an advertisement, which may be the amount of time that the consumer is exposed to the advertisement, whether all at one time, or in periodic or other intervals. For example, in the methods of the invention, a consumer may be exposed to a security bin and/or security bag having one or more advertisements affixed thereto several different times: (a) prior to placing any personal and/or other items into a security bin and/or security bag; (b) at the time of placing such items into the security bin and/or security bag; and (c) after the security bin and/or security bag has been processed through some type of a security screening process at a security checkpoint, such as an x-ray device, a metal detector or a manual inspection.

The phrase “Cost of Goods” as used herein means the cost(s) associated with the manufacturing, printing, installation and/or distribution of one or more security containers and/or their corresponding advertising materials.

The term “entity” as used herein means a household, a business, a corporation, a partnership, a village, a town, a city, a state, a country or a similar type of group.

The term “gifting” as used herein means bestowing by one person or entity to another person or entity something that has some type of value, such as an amount of money, or a piece of personal or real property, voluntarily and without any compensation or other consideration.

The phrase “gross revenue” as used herein means income received from the sales of goods and/or services, such as advertising sales, over some given period of time, such as one month, two months, three months, four months, five months, six months, one year or the like. Any appropriate or desirable period of time may be used.

The phrase “net revenue” as used herein means income received from sales of goods and/or services, such as advertising sales, over some given period of time, such as one month, two months, three months, four months, five months, six months, one year or the like, minus (less) one or more operating costs and/or other costs, such as costs associated with merchandise that is returned, damaged, undeliverable or the like, and/or Cost of Goods.

The phrase “personal items” as used herein includes, for example, purses, wallets, sets of keys, keys, cell phones, pagers, money (change, bills, etc.), jewelry, luggage, laptops (or other) computers, digital or other cameras, video equipment, electronic equipment, luggage, items of clothing (coats, jackets, sweaters, shoes, boots, hats, scarves, gloves, mittens, etc.), other objects that may be carried or transported by a human being onto an airplane, onto a ship, or at a seaport (i.e., carry-on luggage), and/or the like.

The term “plurality” as used herein means more than one, such as two, three, four, five, six, seven, eight, nine, ten, fifteen, twenty or the like.

The term “procure” as used herein means to find, locate, get, obtain or acquire.

The term “public” as used herein means one or more individuals (human beings) that have an ability to be present in a location in which they can be exposed to one or more advertisements (by viewing them, handling them, both, or otherwise), such as in a security area of an airport and/or seaport, which are typically potential consumers.

The term “revenue” as used herein means the amount of money or other consideration that an individual, company or other entity earns from its activities in any given period of time, mostly from sales of products and/or services to customers, for example, the amount of money earned by a security container distriburtor by advertising sales in exchange for permitting an advertiser to place one or more advertisements on one or more security containiers in an airport or seaport. Revenue is often referred to as the “top line” due to its typical position on an income statement at the very top. This is to be contrasted with the “bottom line,” which generally denotes net income (revenues after all applicable costs). Revenue is typically simplified in economics or basic finance projections to “Price×Quantity,” for example, the price of a good times the number of the goods sold. Revenue, like all income statement accounts, may typically only be presented in terms of a period, for example, the revenues a company earns between two specified dates, such as the first and last day of a month, quarter (of a year), 6-month period, 9-month period, year, 2-year period, 5-year period and the like. The Financial Accounting Standards Board's (FASB) Statement of Financial Accounting states that revenues should be recognized when they are “realized or realizable” and “earned.” Revenues are generally “realized or realizable” when products and/or services are exchanged for assets (such as cash) or claims to assets (such as promises to pay). Revenues are generally “earned” when an individual or entity has performed all duties that are necessary for a purchaser. If assets are received before revenue is earned, a liability account is typically created called “unearned revenue.” In general, revenue should be recognized at time of delivery of goods or performance of services. If cash is received prior to this time, revenue is generally unearned. If cash has not yet been received at the time of performance, the asset account “accounts receivable” should generally show this fact. Revenue is generally a crucial part of any financial analysis. A company's performance is measured to the extent to which its asset inflows (revenues) compare with its asset outflows (expenses). Net Income is the result of this equation, but revenue typically enjoys equal attention during a standard earnings call. Gross Margin is a calculation of revenue less Cost of Goods Sold, and is used to determine how well sales cover direct variable costs relating to the production of goods.

The phrase “revenue sharing” as used herein means the sharing of a portion of revenues (from 1% to 100%) generated from advertising sales earned from an advertiser by a security container distributor (or other entity) with an airport and/or seaport (or other entity). Generally, such sharing of revenues occurs in a manner that permits an airport and/or seaport to increase revenue without requiring it to make any initial or other investment.

The term “seaport” as used herein means a place or facility, such as a harbor or town, from which, or to which, a boat, ship, submarine and/or other water vessel, for example, a cruise ship, other leisure sea vessel or naval ship, can depart, return, dock and/or discharge cargo, and includes one or more owners of a seaport or water vessel, water vessels themselves, such as cruise ships, or governing seaport authorities, for example, in the case in which a seaport is owned by one or more separate entities, such as a town, or the Transportation Security Administration (TSA) or coast guard.

The phrase “seaport security area” as used herein means a security area and/or security checkpoint in, near or in connection with a seaport, for example, on a cruise ship, where a person and/or his or her personal items are screened, searched and/or otherwise checked by human beings and/or x-ray, scanning, metal detecting, particulate matter sensing and/or other machines prior to permitting the person and/or his or her personal items to leave that area of the seaport and/or enter another area of the seaport. Typically, a person travels through a metal detector area and removes various items from his or her pockets and places the personal items in a bin that travels along a conveyer belt to be hand checked and/or machine checked.

The phrase “security area” as used herein means any place, area, location and/or facility in an airport and/or seaport in which individuals and/or personal items are examined for some type of a security threat and/or danger in some manner, such as by an x-ray machine, a metal detector, manual inspection or the like. For example, prior to arriving at a gate of an airplane in an airport, all air travel passengers generally must travel through some type of a security area and place all personal items into one or more security bins that are placed upon a conveyer belt and pass through an x-ray machine, metal detector or similar type of machine. Likewise, in this same area, the passengers must generally walk through some type of a security device that can detect metal (guns, knives, and the like). Similar areas are often present at seaports, for example, on cruise ships (usually at the place of entrance and/or exit from the cruise ship).

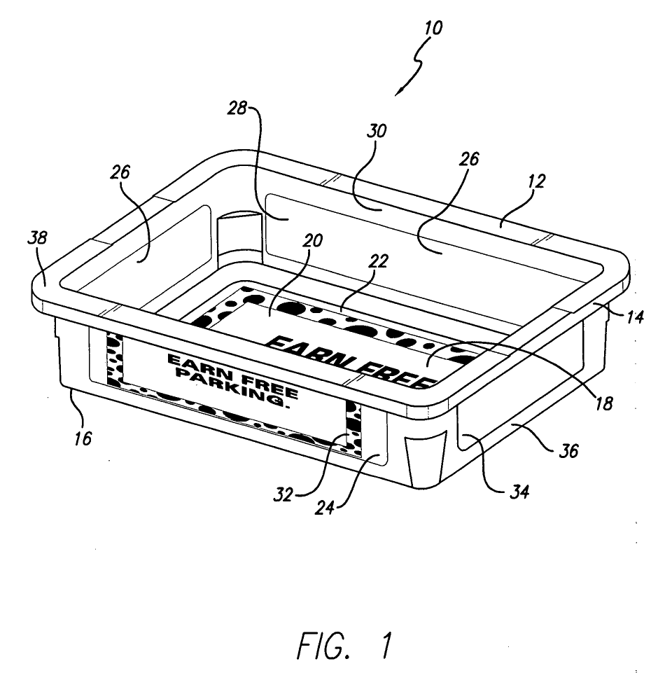

The phrase “security bin” as used herein means a container or tray that is suitable for a temporary transportation, containment and/or storage of one or more personal items in a security area of an airport and/or seaport. Security bins typically have a rectangular base and four upwardly extending walls. An example of a security bin is shown in FIG. 1.

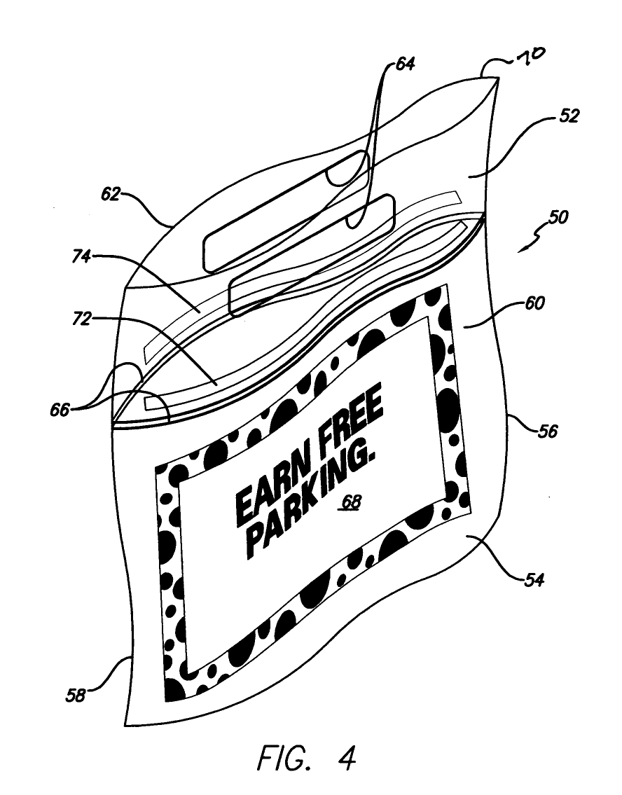

The phrase “security bag” as used herein means a bag that is suitable for a temporary transportation, containment and/or storage of one or more containers (preferably from one to five containers) that can contain or house three ounces or less of a liquid or semi-liquid substance in a security area of an airport and/or seaport and/or in an airplane or sea vessel. An example of a security bag is shown in FIG. 4.

The phrase “security container distributor” as used herein means an individual, corporation, partnership, company and/or other entity that manufactures and/or distributes to an airport and/or seaport one or more security containers, such as security bins and/or security bags, that may be used in an airport and/or seaport security area, or its agent, representative or other designee.

The phrase “single source revenue stream” as used herein means revenue that is shared by one entity (rather than a plurality of entities), such as a security container distributor, with another entity, such as an airport and/or seaport. The revenue that is shared comes from only one source, rather than a plurality of sources, such as a security container distributor.

The phrase “turn key” as used herein means that, once an agreement is reached or signed between an airport and/or seaport and a security container distributor to implement a revenue share agreement in connection with their security screening area(s), preferably every aspect of the program, including all costs associated with implementing and running the program, are taken care of (paid for and undertaken) by the security container distributor. It includes, but is not limited to, the providing of all security containers to each airport and/or seaport, the sourcing of all approved advertisers, the coordinating of, and signing off on, all ad copies with both airports and/or seaports and advertisers, ad installation, security container installation, regular security container maintenance and cleaning, 24 hour operational support 365 days per year, complete insurance coverage, all bookkeeping and tracking of revenue from accounts receivable, checks provided to each airport and/or seaport based upon the percentage of revenue share as agreed upon between the parties, and the providing of all quarterly reports to each airport and/or seaport that outlines all aspects of the program.

The phrase “with no substantial investment” as used herein in connection with an airport and/or seaport means that the airport and/or seaport does not make a substantial investment financially or otherwise in exchange or consideration for receiving one or more security containers, or a share of revenue, from a security container distributor (or other entity). Typically, this means that an airport and/or seaport does not pay more than about 50% of the total costs associated with the total number of security containers provided to it, for example, 0, 1, 2,3, 4, 5, 6, 7, 8, 9, 10, 11, 12, 13, 14, 15, 16, 17, 18, 19, 20, 25, 30, 35, 40, 45 or 50 percent.

The phrase “zip-top” as used herein in connection with a security bag means that the bag has a zip-type lock generally somewhere in the upper (top) area of the bag, for example, at the upper-most portion of the bag, which can be zipped to close the bag and/or seal the contents of the bag away from the environment outside of the bag. Zip tops are conventionally used with plastic bags, such as sandwich bags, and are known by those of skill in the art.

General Description and Utility

The present invention provides methods that are useful for advertising in one or more airport and/or seaport security areas, which are efficient and extremely financially attractive for airports and/or seaports. In these methods, revenue that is generated, or otherwise results, from advertising sales fees that are collected by a security container distributor from one or more advertisers as a result of a sale of one or more advertisements is shared in a revenue sharing program by the security container distributor with an airport and/or seaport. These methods are very beneficial financially to airports and/or seaports, which generally have no financial obligations(s) in connection with either the security container distributor or the advertiser, and yet receive from the security container distributor both: (a) one or more airport security containers, such as security bins and/or security bags, that may be used by the airport in an airport security area (free of charge or with no initial or substantial investment); and (b) in a revenue sharing program, contract and/or other agreement between the security container distributor and the airport and/or seaport, a share of the revenue paid by the advertiser to the security container distributor resulting from the sales of the one or more advertisements. The advertisements that are employed in and/or on the security containers can provide precise messaging and branding opportunities for business and leisure travelers, as well as stable, single source revenue streams for airports and/or seaports with no up-front and/or other costs or investments.

The methods of the invention are extremely advantageous to airports and/or seaports because these entitires are generally provided free of charge with one or more products (security containers) that they would otherwise have to purchase, often at the expense of travel customers and/or the general public. The airports and/or seaports receive products (i.e., security bins and/or security bags) from one or more security container distributors at no charge and, thus, are able to eliminate this cost, which may be very significant, because a typical cost of one security bin is about $8.00, and a typical cost of one security bag is about $0.25, and airports and seaports typcially use from about 500 to about 10,000 security bins, depending on their size and the number of security screening areas and/or screening lanes present therein, and from about 1,000 to about 50,000 security bags, each day. Thus, in this scenereo, the typical cost savings for airports and/or seaports can range from about $4,000 to about $80,000 for security bins, and from about $250 to about $12,500 for security bags, each day (i.e., a combined savings ranging from about $4,250 to about $92,500 each day).

Security Bins

One type of a security container that may be employed in the methods of the invention is the security bin 10 that is illustrated in FIGS. 1, 2 and 3.

The security bin 10 typically has a top 12, a lip 14 (the top portion that extends outwardly in a horizontal direction past its walls 24), a bottom 16 (base), four upwardly extending walls 24 and four corners 38. However, it may have any other suitable number of walls 24 and/or corners 38, such as three, five, six, seven, eight, nine, ten, eleven, twelve and so forth.

The bottom 16 of the security bin 10 is typically rectangular in shape, but may be of any other appropriate or desired shape, and typically has one interior surface 18 (facing the ceiling) to which one or more advertisements may be affixed, which typically has a recessed area 20 and a non-recessed area 22. The advertisements are typically affixed to the recessed area 20, but may also, or alternatively, be affixed to the non-recessed area 22. When the advertisements are affixed to the recessed area 20, they generally have more protection against damage and/or destruction, such as scratching, tearing or the like.

Each wall 24 of the security bin 10 generally has one or more interior surfaces 26, and one or more exterior surfaces 32, upon both of which one or more advertisements may be affixed. The interior surfaces 26 of the walls 24 of the security bin 10 preferably have one or more recessed areas 28 and one or more non-recessed areas 30. The exterior surfaces 32 of the walls 24 of the security bin 10 also preferably have one or more recessed areas 34 and one or more non-recessed areas 36. The recessed areas 28 and 34 of the walls 24 of the security bins 10 provide surfaces to which one or more advertisements may generally be readily affixed, and generally help protect an advertisement located thereon from rubbing against an exterior surface 32 of a second or other security bin 10 during stacking, or from experiencing other damage or destruction, resulting in a savings of money and time associated with a replacement of one or more advertisements as a result of such damage or destruction. The advertisements may also, or alternatively, be affixed to the non-recessed areas 30 and 36 of the surfaces 26 and 32 of the walls 24 of the security bins 10.

The amount of any type of recessing that is present in a security bin 10 can be varied in any manner desired, taking into account, for example, the thickness of an advertisement. A recessing of between approximately one-sixteenth and one-quarter of an inch is preferred, and a recessing of between about one-sixteenth and about one-eighth of an inch is more preferred.

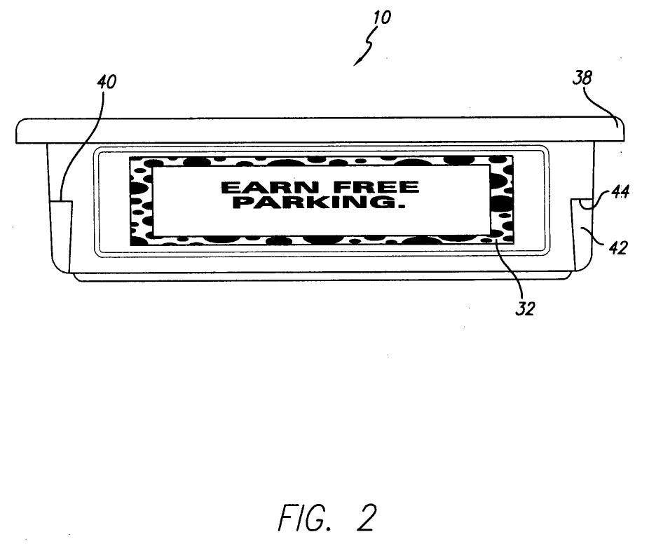

As is shown in FIG. 2, the security bins 10 may also include one or more ledges 40, one or more cut away sections 42 and one or more ledge contacting portions 44.

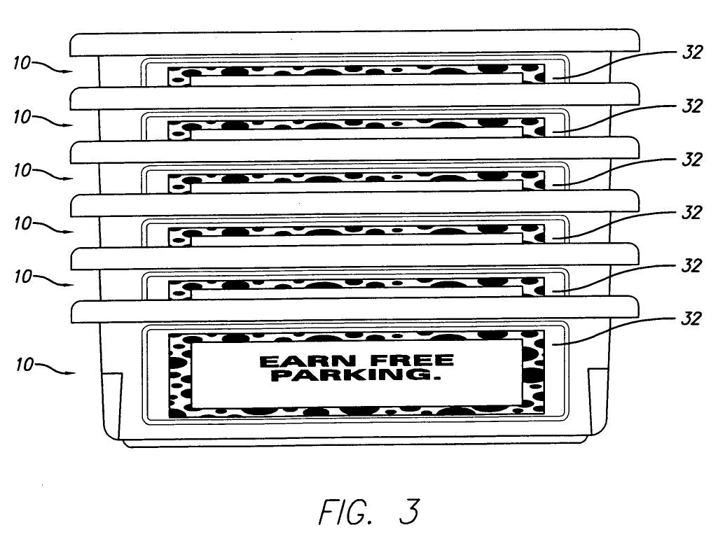

As is shown in FIG. 1, the corners 38 of the security bins 10 are preferably raised, and function to facilitate a stacking of a plurality of security bins 10 in a manner that permits at least a portion of one or more advertisements located on one or more exterior surface 32 of the security bins 10 to remain visible. This typically provides potential consumers with an ability to view one or more advertisements located on the exterior surfaces 32 of the walls 24 of the security bins 10 even when they are in a stacked configuration (FIG. 3), and before the consumers may have picked up one or more security bins 10 from a stack when traveling through an airport or seaport security area, providing additional advertisement exposure time to the potential consumer.

A ledge 40 is preferably provided in the interior of each corner 38 of a security bin 10. The height of the ledges 40 will typically determine the size of a portion of an advertisement located on an exterior surface 32 on a first security bin 10 that will remain visible after such security bin 10 has been inserted into a second security bin 10. The height and size of the ledges 40 may vary widely, and may depend upon the sizes of the security bins 10.

As shown in FIG. 3, it is preferably to provide at the exterior of each corner 38 a cutaway section 42, terminating in a ledge-contacting portion 44. The configuration of these structures is intended to mate with that of the ledge 40, with the cut-away section 42 extending past the ledge 40, and with the ledge-contacting portion 44 coming to rest on the ledge 40, and terminating the downward travel of an inserted security bin 10.

The security bins 10 may, optionally, also include one or more wheels, preferably located adjacent with the outer surface of the bottom 16 of the security bins 10, which may permit the security bins to roll on a flat surface, such as a table or floor. Security bins 10 are conventional, and are routinely used in airport and/or seaport security areas. Generally, they are stackable, so that a plurality of the security bins 10 may be stacked together neatly without taking up much space. The security bins 10 generally have specified areas, such as inner and/or outer surfaces 26 and 32 on one or more of the four upwardly extending walls 24 of the security bins 10, or the interior surface 18 of the bottom 16 of the security bins 10, for allowing one or more advertising materials to be affixed thereto in a manner that they can readily be viewed by the public when passing through an airport or seaport security area.

Preferably, the security bins 10 include at least a partial display of exterior advertising when a plurality of security bins 10 have been placed into one or more stacks (with one security bin 10 being placed into another security bin 10, and that security bin being placed 10 into another security bin 10, and so forth, as is shown in FIG. 3).

Also preferably, the security bins 10 are configured or installed in a security area of an airport and/or seaport so as to permit one or more advertising materials to be changed out (removed and replaced with one or more new and/or different advertisements) as often as is necessary or desired, so that different advertisements of one or more different advertising or other companies can be represented on the security bins 10 without the need for using new security bins. Either the advertisements themselves may be changed out, or the security bins and/or security bags having one or more advertisements affixed thereto, may be changed out. Alternatively, the advertising material may be permanently attached to the security bins 10 and/or security bags. For example, at a time designated for advertising change-out, which may be any convenient, desired and/or agreeable time, replacement security bins 10 and/or security bags with new, approved advertising material already installed on them may be exchanged with security bins 10 and/or security bags containing old (previously used for some designated period of time, which may be any period of time) advertisement materials. The replaced security bins 10 and/or security bags having the old advertising material affixed thereto may then be taken, having old advertising material removed therefrom, completely cleaned, and having new and/or different advertising material placed on the newly refurbished security bins 10 and/or security bags to be reused during the next advertising material swap-out. Such a procedure may take place at any convenient or agreeable time, such as biweekly, weekly, bimonthly, monthly, quarterly, biannually or annually. It is preferably that such procedure take place during a time when the airport and/or seaport has few or no travel passengers in any given security area(s), such as from midnight until 5:00 a.m. (so that the procedure does not interfere with security screening of the passengers and/or their personal items).

Optionally, the security bins 10 may include one or more advertisement holders (not shown), such as plastic, rubber or metal snap frames or sleeves of an appropriate width, length and thickness, which are known by those of skill in the art, into which one or more advertisements may be removably or non-removably slid, inserted or otherwise placed. A wide variety of such holders, and sizes and shapes thereof, are known by those of skill in the art. One or more of such holders would typically be located in the same area(s) of the security bins 10 that one or more advertisements are to be affixed. One or a plurality of such holders may be present in each security bin 10.

Also optionally, the security bins 10 may include some type of a clear protective material or sheets (not shown) that may be placed over one or more advertisements (with or without the use of a holder) in a manner that partially or fully protects an advertisement from damage or destruction, such as scratching, tearing, ripping, falling off of the security bin 10 and the like. Preferably, such material is water resistant or water proof, and scratch resistant or scratch proof. Such materials and sheets are known by those of skill in the art.

Typically, airport and seaport security bins 10 measure approximately 21 inches in length, approximately 17 inches in width, and approximately 6.25 inches in height, and approximately one-eighth to one quarter of an inch in thickness, and are rectangular in shape. However, the size and shape of the security bins 10 is not critical to the methods of the present invention, and any other appropriate and/or desirable sizes and/or shapes may be employed, such as security bins 10 that are circular, square, triangular, hexagonal or octagonal in shape. The security bins 10 may be partially or fully clear (see through) and/or opaque, or a combination thereof, and may be of any desired color, such as white, tan, gray, black, green, red, blue, multicolored or the like. They may be made of any material, or combination of materials, that is appropriate for containing items, such as plastic, rubber, glass (preferably non-breakable), metal and/or another suitable material, which materials are known by those of skill in the art. Preferably, the security bins 10 measure from about 19 to about 22 inches in length, from about 16 to about 18 inches in width, from about 5.5 to about 7.5 inches in height, and from about one-eight to about one-quarter of an inch in thickness, and are made of a durable plastic material.

The number of security bins 10 that any given airport and/or seaport might use or need depends, in part, upon the number of security areas and/or security lanes, and passengers, present therein. For example, the airport in Tulsa, Okla. only requires about 500 security bins because it has only three security lanes. In contrast, the airport in Atlanta, Ga. would likely use about 5,000 security bins, and the John F. Kennedy International Airport (New York), which has multiple terminals, could require as many as 10,000 security bins.

A security container distributor may provide an airport and/or seaport with any appropriate or desired number of security bins 10 at any given time, such as 1, 2, 3, 4, 5, 6, 7, 8, 9, 10, 15, 20, 25, 30, 35, 40, 45, 50, 75, 100, 150, 200, 250, 300, 350, 400, 450, 500, 750, 1,000, 1,500, 2,000, 3,000, 4,000, 5,000, 6,000, 7,000, 8,000, 9,000, 10,000, 11,000, 12,000, 13,000, 14,000, 15,000, 16,000, 17,000, 18,000, 19,000, 20,000 25,000 and so forth daily, biweekly, weekly, bimonthly, monthly, quarterly, biannually or annually, and so forth. However, the security container distributor will preferably provide an airport and/or seaport with from about 250 to about 10,000 security bins 10 at one time (usually in connection with a contract or other agreement), and will more preferably provide an airport and/or seaport with from about 250 to about 5,000 security bins 10 at one time, and will still more preferably provide an airport and/or seaport with from about 250 to about 2,000 security bins 10 at one time.

The security bins 10 may be changed out (exchanged out for newer, different, less damaged and/or cleaner security bins 10) at any desired or appropriate time, such as weekly, biweekly, monthly, bimonthly, quarterly, biannually, annually and so forth. It is, however, preferable that such security bins 10 be changed out quarterly.

Optionally, but preferably, a security container distributor may replace any lost, damaged, dirty and/or stolen security bins 10 for an airport and/or seaport on a regular basis, such as daily, biweekly, weekly, bimonthly, monthly, quarterly, biannually or annually and so forth, or for any given number of times, such as 1, 2, 3 , 4, 5, 6, 7, 8, 9, 10, 15 or 20 or more times, within any given period of time.

The security bins 10 that are employed in the methods of the invention may be manufactured by methods that are known by those of skill in the art, or purchased from known manufacturers and/or distributors, such as Seiler Plastics (St. Louis, Mo.).

Security Bags

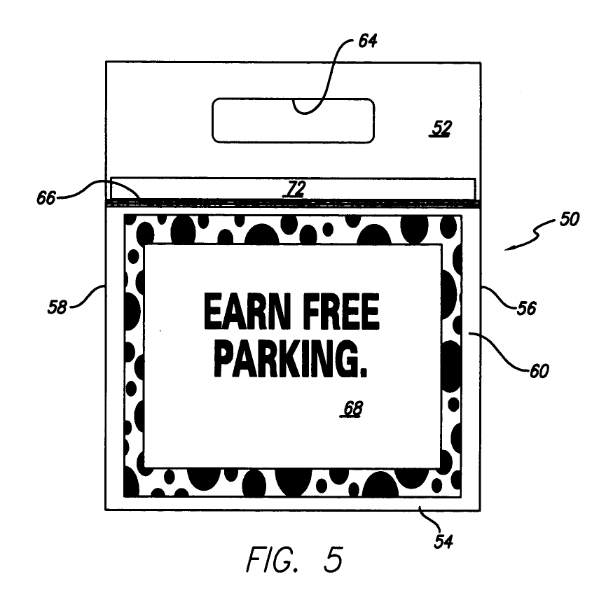

Another type of a security container that may be employed in the methods of the invention is a security bag 50, such as a clear, quart-sized, plastic, zip-lock bag, which is illustrated in FIGS. 4 and 5. Such security bags 50 have been approved by the TSA for containing and transporting containers of liquids that hold three ounces or less of a liquid or semi-liquid substance or material, and that are to be carried onto an aircraft.

A security bag 50 typically has a top 52, a bottom 54, a right side 56, a left side 58, a front 60, a back 62, a handle 64 and a lock (zip lock) 66. The front 60 and the back 62 of the security bag 50 generally each have one or more surfaces or areas 68 and 70, respectively, upon which, or to which, one or more advertisements may be affixed. The front 60 and the back 62 of the security bag 50 may also include an area 72 and 74, respectively, stating “Approved Message,” or a similar message.

A security bag 50 preferably measures approximately 10 inches in width and approximately 12 inches in height, with an approximately 7 inch length from the zip lock to the bottom of the bag, and is rectangular or square in shape. However, the size and shape of the security bags 50 may be varied, as other sizes and shapes may be employed. Typically, the security bags 50 can hold from about 1 to about 5 bottles or containers (glass, plastic, rubber, etc.) that may contain three ounces or less of a liquid or semi-liquid substance or material. Preferably, the security bags 50 measure from about 6 to about 12 inches in length, from about 7 to about 12 inches in width, and from about one-thirty-second to about one-sixteenth inches in thickness.

The security bags 50 may be clear (see through) or opaque, or a combination thereof, and may be of any desired color or combination of colors. They are preferably made of clear plastic, but may be made of any other suitable or desired material, such as paper, cardboard, material (cotton, wool, etc.) or rubber, or a combination thereof. The security bags are preferably made of Polyethylene—Low Density Polyethylene (LDPE), Polyethylene—High Density Polyethylene (HDPE), Polypropylene, PET, Poly-nylon or Laminate, or a combination thereof.

The number of security bags 50 that any given airport or seaport might use or need also depends, in part, on the number of security areas, security lanes and passengers that are present therein. The airport in Tulsa, Okla., for example, could use as few as about 1,000 security bags 50 (which would be very low) to as many as about 100,000 security bags 50 in one month. The airport in Atlanta, Ga. would likely use anywhere from about 10,000 to about 1,000,000 security bags 50 in one month, and the John F. Kennedy International airport could used as many as about 1,500,000 security bags 50 in one month.

A security container distributor may provide an airport or seaport with any appropriate or desirable number of security bags 50 at any given time, such as 1, 2, 3, 4, 5, 6, 7, 8, 9, 10, 15, 20, 25, 30, 35, 40, 45, 50, 75, 100, 150, 200, 250, 300, 350, 400, 450, 500, 750, 1,000, 1,500, 2,000, 3,000, 4,000, 5,000, 6,000, 7,000, 8,000, 9,000, 10,000, 15,000, 20,000, 25,000, 30,000, 35,000, 40,000, 45,000, 50,000, 55,000, 60,000, 65,000, 70,000, 75,000, 80,000, 85,000, 90,000, 95,000, 100,000, 200,000, 300,000, 400,000, 500,000, 600,000, 700,000, 800,000, 900,000, 1,000,000, 2,000,000, 3,000,000, 4,000,000, 5,000,000 and so forth daily, biweekly, weekly, bimonthly, monthly, quarterly, biannually, annually and so forth. However, the security container distributor will preferably provide an airport or seaport with from about 1,000 to about 100,000 security bags 50 at one time (usually in connection with a contract or other agreement), and will more preferably provide an airport or seaport with from about 10,000 to about 25,000 security bags 50 at one time.

The security bags 50 are preferably “one-time use” bags that will only be used one time (will not be reused), and will be discarded after use on an airplane or at a seaport. However, in the methods of the invention, it is possible to use security bags 50 that may be used a plurality of times, such as two times. In such a case, the security bags 50 may be changed out (exchanged for newer, different, less damaged and/or cleaner security bags 50) at any desired or appropriate time, such as daily, biweekly, weekly, bimonthly, monthly, quarterly, biannually or annually, and so forth.

The security bags 50 that are employed in the methods of the invention may be manufactured by methods that are known by those of skill in the art, or may be purchased from known manufacturers and/or distributors, such as Four Star Plastics (Beltsville, Md.) or BagBarn.com (Madison, Ind.).

Advertisements

The one or more advertisements that may be affixed to one or more surfaces or areas of the security containers in accordance with the methods of the invention may be made of paper, cardboard, another paper-like material, plastic, rubber, metal or of any other conventional material for use with advertisements, and may be screen or otherwise printed directly onto one or more surfaces of the security containers. The advertisements preferably have a flat, rather than a three-dimensional, configuration, an outer surface with black and white and/or color print and/or graphics set forth thereon, and an inner surface that can be affixed to one or more surfaces of the security containers. The advertisements may be of any appropriate or desired size and/or thickness, as would be known by those of skill in the art, and may depending upon the size and type of security container used, for example, from about 2 to about 21 inches in length, from about 2 to about 17 inches in width, from about one-half to about 6 inches in height, and from about one-thirty-second to about one-sixteenth inches in thickness. Advertisements are typically ⅛, 1/10, 1/12, 1/14 or 1/16 of an inch in thick.

It is preferable to place the one or more advertisements in one or more highly visible positions, areas or surfaces of the security bins 10 and/or security bags 50, for example, on the exterior surfaces 32 of the walls 24 of the security bins 10 and/or security bags 50, so that they preferably can be viewed at all times by the public that is traveling through an airport and/or seaport security area, security lane and/or security checkpoint and/or airport and/or seaport security personnel, all of whom are potential consumers of the goods and/or services that are being advertised in the advertisements. The advertisements may cover any portion of any appropriate surface or area on a security container (i.e., the entire surface (100%), or any portion thereof (from about 1 to about 99%)), such as the interior and/or exterior surfaces on the security bins 10 and security bags 50. Multiple, high impact, clutter free, full color advertisements that allow a captivating connection between an advertiser and consumers are preferred, such as 20″×15″ full color advertisements on or in security bins 10, and 9″×6″ full color advertisements on or in security bags 50.

Advertisements can be affixed to the security bags 50 and security bins 10 using conventional methods known by those of skill in the art, for example, gluing, imprinting, sublimation, silk-screening and the like.

The total amount of time that any one advertisement will be before the public (consumer impression time) in accordance with the methods of the invention preferably ranges from about 30 seconds to about 720 hours per month. Generally, consumer impression time is figured by the amount of time that one advertisement can reach one consumer over a given period of time, which may be any period of time. In regards to security bins 10, it preferably ranges from about 30 seconds to about 30 minutes within one day, and more typically ranges from about 30 seconds to about 5 minutes within one day, depending if a security line is bottlenecked or delayed and, thus, whether or not a particular passenger is able to view one or more advertisements on one or more security bins 10 being used by one or more other passengers that are in a security line (usually in front of them in line). Security bags 50, however, are somewhat different from security bins 10 in that they are typically before a passenger for a period of time ranging from about 30 seconds to about 5 minutes in one day. They, however, are a bit unique in that the passenger actually takes the security bag 50 with him onto an airplane or water vessel, and may continue to use the security bag 50 during the entire trip and, possibly, beyond. The passenger can even personally re-use the security bag 50 for a future trip (to be prepared for security issues), thus resulting in a consumer impression time ranging from about 30 seconds to several days or more. Daily consumer impression times for both security bins 10 and security bags 50 may, for example, be 1, 2, 3, 4, 5, 6, 7, 8, 9, 10, 11, 12, 13, 14, 15, 20, 25, 30, 35, 40, 45, 50, 55 or 60 minutes,or 1, 2, 3, 4, 5, 6, 7, 8, 9, 10, 11, 12, 13, 14, 15, 16, 17, 18, 19, 20, 21, 22, 23 or 24 hours.

Both the security bins 10 and the security bags 50 are somewhat unique in that they can provide consumer impression times by having a consumer picking up and/or touching one or more advertisements that may be affixed to the security bins 10 and/or security bags 50. In contrast, most other types of advertisements are simply visual or audio. Permitting a consumer to visually view an advertisement, and also touch and/or hold the advertisement, is very beneficial, and increases the value of the consumer impression.

Any number of different advertisements may be used on one or more security containers, or in one or more security areas, at any given time, for example, 1, 2, 3, 4, 5, 6, 7, 8, 9, 10, 11, 12, 13, 14, 15 and so forth. However, in order to produce the greatest impact on consumers, and generate the highest possible amount of revenue sharing profits for each airport and/or seaport, it is preferable to have no more than from about 1 to about 4 different advertisements present in any one security area at any given time. It is also preferable to have no more than from about 1 to about 4 different advertisements be present on any one security container at any given time.

Advertisements may be changed out (one or more advertisements replaced with one or more different, new, less damaged and/or cleaner advertisements) as many times as desired or necessary during any given period of time, such as 1, 2, 3, 4, 5, 6, 7, 8, 9, 10, 11, 12, 13, 14, 15, 20, 25, 30, 35, 40, 45, 50, 75, 100 and so forth times daily, biweekly, weekly, bimonthly, monthly, quarterly, biannually, annually and so forth. However, it is preferably that all advertisements be changed out one timer per month, preferably on the first or last day of the month.

Although it is not necessary, it is preferable that all advertisements being displayed on security containers are coordinated by the security container distributor to ensure that the advertisements are appropriate or desirable for the characteristics or demographics of each airport, seaport and/or region. For example, it would likely not be desirable to place an advertisement for a particular brand of cigarettes, such as Marlboro or Winston, and/or alcohol, such as Kettle One vodka, on a security container that is to be placed in an airport that is located in a geographic area that historically has a low percentage or population of smoking and/or alcohol consumption, such as in some areas of Utah.

In the methods of the invention, a security container distributor may provide complete methodology from sourcing the advertiser through advertisement installation, distribution and operational and maintenance support.

The initial advertisement installation may, for example, be completed by one or more third parties (contracted or not with the security container distributor) that preferably have credentials that are appropriate for each venue including, for example, FAA/TSA security clearance for access to airport and/or seaport locations. It may be desirable to have multiple suppliers because of geographically disparate locations of airports and/or seaports.

The professional management of some or all initial advertisement installations can assure that there is consistency and quality in each application of the methods of the invention. For example, the security container distributor may contract other entities, such as other distributors, having one or more operations in each airport and/or seaport location to change out advertisements on a periodic basis.

Two benefits of using a distribution network that may already be in place are as follows:
(1) employees will typically have had appropriate background checks, and have obtained necessary clearance for site access, including FAA/TSA security clearance for access to airport and/or seaport locations; and
(2) precise programs for complete distribution may already be in place for airports and/or seaports, and may keep costs low, and guarantee the product (security containers and/or advertisements) will be replaced on time and in a professional manner.

Revenue Sharing

In the methods of the invention, revenue is generated, or results, from the sale of advertisements that are to be placed upon the security bags 50 and/or security bins 10. An advertiser (individual, company or other entity that seeks to have one or more advertisements displayed on a security bag or security bin) that is typically found or located by a security container distributor pays one or more fees for such service to the security container distributor, generally under some type of a contract or other agreement that has a fixed term, such as three, four, five, six, nine, twelve or twenty four months. The security container distributor, in turn, provides an airport and/or seaport generally free of charge (with no initial or other investment) with security bins and/or security bags that display such advertisements for use with the public and personnel in an airport and/or seaport security area. Additionally, the security container distributor shares all, or a portion, of the gross or net (after expenses) revenue collected from, or promised or contracted by, the advertiser with the airport or seaport, which likely has no type of a revenue share program in place. Thus, the airport or seaport benefits financially by paying no fees or costs, and having no initial investment, and yet receiving security containers bearing one or more advertisements free of charge, as well as advertising sales revenue. This provides a significant financial incentive to the airport or seaport to use security bins and/or security bags including one or more advertisements that are provided by a security container distributor. The security container distributor also benefits financially by receiving advertising fees from the advertiser. The advertiser benefits by having one or more of its advertisements preferably prominently displayed to the public in an airport and/or seaport security area on one or more surfaces of one or more security bins 10 and/or security bags 50. It is typically a “win-win” situation for all entities involved.

In addition to the above, the security container distributor may, optionally, provide an airport and/or seaport with partial or full advertising sales and/or production support, operational support, maintenance and/or quality assurance for all advertisements and/or security containers. For example, the security container distributore may, optionally, provide one or both of the advertiser, and the airport or seaport, with one or more ad copies for approval, produce and/or distribute one or a plurality of advertisements and/or install one or a plurality of advertisements on the security bins 10 and/or security bags 50. The operational support and maintenance may include a fixed term of support and/or maintenance, such as monitoring from about 1 to about 24 hours per day on a daily basis, for example, 24-hour, 12-hour or 6-hour daily monitoring.

A term of an agreement or contract reached between a security container distributor and an advertiser preferably ranges from about 30 days to about 5 years, and more preferably ranges from about 30 days to about 3 years, and more preferably ranges from about 30 days to about 18 months, and still more preferably ranges from about 30 days to about 12 months. Such term may, for example, be a three month, a six month, a nine month, a one year, a two year, a three year, a four year, a five year, a ten year or other fixed term. The same type of a term of an agreement or contract may be employed in an agreement or contract reached between a security container distributor and an airport and/or seaport. It is generally preferably to have both types of terms be the same, or approximately the same.

The revenue sharing program or agreement may take any convenient or desired form, such as revenue sharing and/or outright bartering and/or gifting of the advertising sales proceeds.

In a typical revenue share model, gross or net revenues that are generated by the sale of advertising are divided between the security container distributor and the airport or seaport, generally on a negotiated percentage (from about 0 to about 99% for the security container distributor, and from about 1 to about 100% for the airport or seaport), for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, 100%, or any other desired percentage. Revenues generated as the result of advertising sales are shared in an agreeable percentage between the security container distributor and the airport or seaport.

Standard revenue valuation is preferably based upon Price of Goods×Quantity Sold. For example, if 100 advertisements are sold in a six month period of time at a cost of $100.00 each, the gross revenue earned within that six-month period of time would be $10,000.00, which could be shared between the security container distributor and the airport or seaport in the manner and percentages described herein. If, for example, the airport or seaport was to receive a 40% share of gross revenue, the security container distributor would provide $4,000.00 to the airport or seaport (along with the security containers), preferably in the form of a check at the end of that six-month period. An agreed upon revenue share percentage can be paid to an airport and/or seaport either prior to, or after, a deduction of Cost of Goods based on agreements between the airport and/or seaport and the security container distributor.

The revenue sharing step(s) of the method of the present invention may be varied in any desired manner by the security container distributor and/or the airport and/or seaport. For example, the percentage of revenue shared by a security container distributor with an airport and/or seaport can start at one percentage, such as 5%, over a specified period of time, such as six months or one year, and then increase or decrease to a different percentage, such as 10%, over the same or a different specified period of time, such as six months or one year, and then increase or decrease to yet another different percentage, such as 15%, over the same or a different specified period of time, such as six months or one year, and so forth. An escalation in revenue sharing percentages can provide additional incentives for airports and seaports to enter into a program as described herein with a security container distributor.

In addition to revenue sharing, the gifting and/or bartering of a product and/or the revenue generated from advertising sales using the product may also occur. The method that is employed (revenue sharing, gifting and/or bartering) will preferably be determined according to an airport's and/or seaport's preference.

Other Aspects of Method

The methods of the present invention may also, optionally, include one or more of the steps or aspects set forth below.
(a) Preparation and/or review of one or more (or all) legal agreements, such as contracts, optionally, with each company utilizing a media venue.
(b) Determining and/or finding one or more appropriate advertisers for each airport and/or seaport region or location, to ensure that an advertising brand (e.g. Coca Cola) does not conflict with an airport brand (e.g., Oklahoma City airport).
(c) Reviewing of one or more (or all) ad copies obtained from each advertiser prior to printing ad copy.
(d) Providing one or more (or all) ad copies to be reviewed by each airport and/or seaport relative to each location or region prior to printing ad copy.
(e) Obtaining airport and/or seaport approval and/or sign-off of one or more (or all) ad copies, including advertisement size, thickness, type, color, other appearance and content.
(f) Once an ad copy has been reviewed and signed off on (approved) by an airport, seaport or other entity, sending the ad to print at a printing company or other entity that has an ability to produce advertisements.
(g) Overseeing of one or more (or all) ad copies during printing, including conformance with all quality control measures and timelines.
(h) Reviewing of one or more (or all) printed and/or completed ad copies for quality assurance (to ensure an appropriate or desired quality of the advertisements).
(i) Upon a completion of quality control review of all ad copies, sending or otherwise transporting the advertisement(s) to one or more pre-determined or other distribution locations, such as one or more security areas located in an airport and/or seaport.
(j) Installation of one or more (or all) advertisements on behalf of an advertiser into one or more security containers at the place of business of the security container distributor, at one or more airport or seaport locations, or elsewhere, on one or more appropriate and/or pre-determined dates (which may be any date(s) selected), such as the first day or last of each month or quarter.
(k) During an ad copy change out on one or more (or all) security containers, whether removing old security containers and replacing them with new security containers, possessing new ad copies, or removing old ad copies and replacing them with new ad copies, at airport and/or seaport locations, cleaning thoroughly and/or refurbishing one or more (or all) security containers, ensuring clean, professional and asthetically pleasing appearance of security containers for airport and/or seaport locations, as well as for advertiser(s).
(l) Providing a guarantee to an advertiser and/or airport and/or seaport that one or more (or all) problems or difficulties that may arise in connection with one or more advertisements and/or security containers will be resolved by the security container distributor within a specified period of time (any specified time) after a problem or difficulty is reported, such as within 24, 48 or 72 hours of reporting, to ensure the advertising and/or security container integrity.
(m) Partial or complete replacement of one or more (or all) lost, stolen and/or damaged security containers provided to an airport and/or seaport at no cost within a specified period of time after such incidence is reported, which may be any period of time, for example, within 24 hours of the issue being reported.
(n) At the end of a specified period of time (any specified period of time), such as each quarter, sharing by the security container distributor of the partial or total gross or net revenue resulting from all advertising sales with an airport and/or seaport, preferably in accordance with a previously written agreed upon percentage (either prior to, or after, some or all of the costs incurred in the process by the security container distributor are are deducted from the revenue). The revenue share is preferably provided to the airport without requiring any out-of-pocket costs or initial investment on behalf of the airport or seaport. The security container distributor preferably shares such revenue with and airport and/or seaport by sending a check to the airport and/or seaport.
(o) Providing, partial or fully (24 hours per day, 7 days per week, for 365 days per year) client relations, operational support, quality control and/or maintenance in connection with one or more (or all) advertisements and/or security containers, which will generally ensure that the method or program is partially or fully (preferably fully) effortless and/or worry-free for the airport or seaport. (The airport(s) and/or seaport(s) should only need to approve ad copies, and yet receive security container(s) and a share of the advertising sales revenue, for example, in the form of a quarterly check provided by the security container distributor.)

Sources of Materials

All of the ingredients, materials and equipment that is employed in the methods of the invention, are commercially available from sources known by those of skill in the art, such as United States Plastic Corp. (Lima, Ohio), Material Handling Solutions (Mission, Tex.), Seiler Plastics (St. Louis, Mo.), Great River Plastics (Lancaster, Wis.), Four Star Plastics (Beltsville, Md.), BagBarn.com (Madison, Ind.), Formetco (Duluth, Ga.) and Graphic Response (Atlanta, Ga.).

The following example also describes and illustrates the methods of the present invention. The example is intended to be merely illustrative of the present invention, and not limiting thereof in either scope of spirit. Those of skill in the art will readily understand that variations of certain of the conditions and/or steps employed in the procedures described in the example can be employed.

### EXAMPLE

The Adason Group (Atlanta, Ga.) enters into a written contract with both O'Hare International Airport (Chicago, Ill.) and Heartsfield International Airport (Atlanta, Ga.). The Adason Group agrees to provide both airports free of charge and with no initial or other investment with 1500 security bins and 50,000 security bags on each of Jan. 1, 2007, Jan. 1, 2008 and Jan. 1, 2009. It also agrees to provide both airports with 30% of net revenue generated by advertising sales of advertisements that may be affixed to security bins and/or security bags that are placed in any or all of the security areas that are present in either or both airports, with such percentage of net revenue being paid to each airport on Jul. 1, 2007 and Jan. 1, 2008. The Adason Group agrees to increase the percentage of net revenue generated from such advertising sales for both airports to 40% starting on Jan. 1, 2008, and to 50% for both airports starting on Jan. 1, 2009. In the years 2008 and 2009, both airports will receive the specified percentage of net revenue by check on Jul. 1, 2008 and Jan. 1, 2009, and on Jul. 1, 2009 and Jan. 1, 2010, respectively. The Adason Group also agrees to provide both airports with total operational support and maintenance in connection with all security bins, security bags and advertisements placed into the airports (on the security bins and/or security bags) 24 hours per day, 7 days per week, 365 days per year.

The Adason Group also enters into a separate written contract with USAD Corp. whereby USAD Corp. agrees to pay The Adason Group a total of $30,000 each year for 2007, 2008 and 2009 in consideration for The Adason Group affixing a variety of different advertisements that advertise goods and services of USAD Corp. clients on the security bins and/or security bags that are placed into one or more security areas within O'Hare International Airport and Heartsfield International Airport during the years 2007, 2008 and 2009.

The Adason Group's total costs in connection with both agreements is $10,000 each year during 2007, 2008 and 2009, resulting in net revenue during each of these years of $20,000. Thus, according to the agreements with the airports, this net revenue would be distributed to the two airports in the following manner: 2007 ($6,000), 2008 ($8,000) and 2009 ($10,000).

While the present invention has been described herein with specificity, and with reference to certain preferred embodiments thereof, those of ordinary skill in the art will recognize numerous variations, modifications and substitutions of that which has been described which can be made, and which are within the scope and spirit of the invention. It is intended that all of these modifications and variations be within the scope of the present invention as described and claimed herein, and that the invention be limited only by the scope of the claims which follow, and that such claims be interpreted as broadly as is reasonable.

Throughout this document, various patents and other publications have been cited. The entireties of each of these patents and other publications are hereby incorporated by reference herein.

What is claimed is:

1. A method for advertising in a security area located in, or outside of, an airport or seaport wherein a percentage of gross or net revenue generated by, or otherwise resulting from, advertising sales fees that are collected by a security container distributor from an advertiser as a result of a sale of one or more advertisements is shared by the security container distributor with the airport or seaport, comprising:
(a) providing by the security container distributor to the airport or seaport free of charge, or with no substantial investment, one or more security containers, wherein the security containers can contain one or more personal items of a traveler that enters into the security area, wherein the security containers are security bins, security bags or a combination of security bins and security bags, and wherein the security containers have one or more surfaces to which one or more advertisements may be affixed;
(b) collecting by the security container distributor from the advertiser of one or more advertisement sales fees in exchange for one or more opportunities by the advertiser to have one or more advertisements affixed to one or more of the surfaces of the security containers;
(c) affixing the advertisements to the surfaces of the security containers at one or more locations, and in a manner that the advertisements are visible to the public or personnel of the airport or seaport when located in the security area;
(d) placing the security containers in the security area in a manner that the security containers are visible to the public or personnel of the airport or seaport when located in the security area; and
(e) sharing by the security container distributor with the airport or seaport of a percentage of all gross or net revenue generated by, or resulting from, the advertisement sales fees.

2. The method of claim 1 wherein the security containers are security bins.

3. The method of claim 2 wherein the security bins are the security bins that are illustrated in FIG. 1.

4. The method of claim 1 wherein the security containers are security bags.

5. The method of claim 4 wherein the security bags are the security bags that are illustrated in FIG. 4.

6. The method of claim 1 wherein the security containers are security bins and security bags.

7. The method of claim 6 wherein the security bins are the security bins that are illustrated in FIG. 1, and the security bags are the security bags that are illustrated in FIG. 4.

8. The method of claim 1 wherein the security containers are provided by the security container distributor to the airport or seaport free of charge.

9. The method of claim 1 wherein the security containers are provided by the security container distributor to the airport or seaport with no substantial investment.

10. The method of claim 9 wherein the financial investment made by the airport or seaport for the security containers does not exceed about 40% of the total costs associated with all of the security containers that are provided by the security container distributor to the airport or seaport.

11. The method of claim 10 wherein the financial investment made by the airport or seaport for the security containers does not exceed about 30% of the total costs associated with all of the security containers that are provided by the security container distributor to the airport or seaport.

12. The method of claim 11 wherein the financial investment does not exceed about 20% of the total costs associated with all of the security containers that are provided by the security container distributor to the airport or seaport.

13. The method of claim 12 wherein the financial investment does not exceed about 10% of the total costs associated with all of the security containers that are provided by the security container distributor to the airport or seaport.

14. The method of claim 13 wherein the financial investment does not exceed about 5% of the total costs associated with all of the security containers that are provided by the security container distributor to the airport or seaport.

15. The method of claim 1 wherein some or all of the advertisements are replaced with new or different advertisements at least one per month.

16. The method of claim 1 wherein the security container distributor replaces all lost, damaged or stolen security containers on a regular basis.

17. The method of claim 16 wherein the lost, damaged or stolen security containers are replaced once each quarter.

18. The method of claim 16 wherein the lost, damaged or stolen security containers are replaced once each month.

19. The method of claim 2 wherein the security container distributor provides the airport or seaport with from about 250 to about 10,000 security bins at one time.

20. The method of claim 19 wherein the security container distributor provides the airport or seaport with from about 250 to about 5,000 security bins at one time.

21. The method of claim 20 wherein the security container distributor provides the airport or seaport with from about 250 to about 2,000 security bins at one time.

22. The method of claim 4 wherein the security container distributor provides the airport or seaport with from about 1,000 to about 100,000 security bags at one time.

23. The method of claim 19 wherein the security container distributor additionally provides the airport or seaport with from about 1,000 to about 100,000 security bags at one time.

24. The method of claim 22 wherein the security container distributor provides the airport or seaport with from about 10,000 to about 25,000 security bags at one time.

25. The method of claim 1 wherein the security containers include one or more security bins, and wherein one or more of the advertisements that are affixed to the security bins has a consumer impression time ranging from about 30 seconds to about 30 minutes in one day.

26. The method of claim 25 wherein the one or more advertisements has a consumer impression time ranging from about 30 seconds to about 5 minutes in one day.

27. The method of claim 1 wherein the security containers include one or more security bags, and wherein one or more of the advertisements that are affixed to the security bags has a consumer impression time that ranging from about 30 seconds to about 120 minutes in one day.

28. The method of claim 27 wherein the one or more advertisements has a consumer impression time ranging from about 30 seconds to about 60 minutes in one day.

29. The method of claim 25 wherein the security containers also include one or more security bags, and wherein one or more of the advertisements that are affixed to the security bags has a consumer impression time ranging from about 30 seconds to about 120 minutes in one day.

30. The method of claim 1 wherein the number of different advertisements that are present in any one security area at one time range from about 1 to about 4.

31. The method of claim 1 wherein the number of different advertisements that are affixed to any one security container at one time range from about 1 to about 4.

32. The method of claim 1 wherein the security container distributor receives a share of the gross or net revenue in a percentage ranging from about 0% to about 99%, and the airport or seaport receives a share of the gross or net revenue in a percentage ranging from about 1% to about 100%.

33. The method of claim 32 wherein the security container distributor receives a share of the gross or net revenue in a percentage ranging from about 0% to about 75%, and the airport or seaport receives a share of the gross or net revenue in a percentage ranging from about 25% to about 100%.

34. The method of claim 33 wherein the security container distributor receives a share of the gross or net revenue in a percentage ranging from about 0% to about 50%, and the airport or seaport receives a share of the gross or net revenue in a percentage ranging from about 50% to about 100%.

35. The method of claim 34 wherein the security container distributor receives a share of the gross or net revenue in a percentage ranging from about 0% to about 25%, and the airport or seaport receives a share of the gross or net revenue in a percentage ranging from about 75% to about 100%.

36. The method of claim 35 wherein the security container distributor receives a share of the gross or net revenue in a percentage ranging from about 0% to about 10%, and the airport or seaport receives a share of the gross or net revenue in a percentage ranging from about 90% to about 100%.

37. The method of claim 8 wherein the security container distributor receives a share of the gross or net revenue in a percentage ranging from about 0% to about 60%, and the airport or seaport receives a share of the gross or net revenue in a percentage ranging from about 40% to about 100%.

38. The method of claim 32 wherein the airport or seaport receives 100% of gross revenue.

39. The method of claim 32 wherein the airport or seaport receives 100% of net revenue.

40. The method of claim 19 wherein the security container distributor provides the airport or seaport with the security bins free of charge, and wherein the airport or seaport receives a share of gross revenue ranging from about 30% to about 100%.

41. The method of claim 19 wherein the security container distributor provides the airport or seaport with the security bins free of charge, and wherein the airport or seaport receives a share of net revenue ranging from about 30% to about 100%.

42. The method of claim 22 wherein the security container distributor provides the airport or seaport with the security bags free of charge, and wherein the airport or seaport receives a share of gross revenue ranging from about 30% to about 100%.

43. The method of claim 22 wherein the security container distributor provides the airport or seaport with the security bags free of charge, and wherein the airport or seaport receives a share of net revenue ranging from about 30% to about 100%.

44. The method of claim 1 wherein the method additionally comprises the step of the security container distributor procuring one or more advertisers for the airport or seaport that have one or more advertisements that do not conflict with an advertising brand used by the airport or seaport.

45. The method of claim 44 wherein the method additionally comprises the step of the security container distributor reviewing one or more ad copies obtained from the advertisers prior to the ad copies being printed.

46. The method of claim 45 wherein the method additionally comprises the step of the security container distributor providing the ad copies to the airport or seaport for review prior to the ad copies being printed.

47. The method of claim 46 wherein the method additionally comprises the step of the security container distributor obtaining airport or seaport approval of the ad copies.

48. The method of claim 47 wherein the method additionally comprises the step of the security container distributor sending or providing the ad copies to an advertisement printing or production entity for printing or production of one or more advertisements.

49. The method of claim 48 wherein the method additionally comprises the step of the security container distributor overseeing the printing or production of the advertisements to ensure a desired quality, time of completion, or both.

50. The method of claim 49 wherein the method additionally comprises the step of the security container distributor reviewing one or more of the completed advertisements to ensure that the advertisements have a quality that is desired by the advertiser, the security container distributor or the airport or seaport, or a combination thereof.

51. The method of claim 50 wherein the method additionally comprises the step of the security container distributor sending or transporting completed advertisements to the security area, to an advertisement installation site, or to another desired location.

52. The method of claim 50 wherein the method additionally comprises the step of the security container distributor installing, or having installed, completed advertisements into the security containers.

53. The method of claim 52 wherein the method additionally comprises the step of the security container distributor maintaining the security containers in a clean, functional or asthetically pleasing condition, of a combination thereof.

54. The method of claim 53 wherein the method additionally comprises the step of the security container distributor providing a guarantee to the advertiser, or the airport or seaport, or a combination thereof, providing that any problem that may arise in connection with the advertisments or security containers, or both, will be resolved by the security container distributor within a specified period of time after the problem is reported to the security container distributor.

55. The method of claim 54 wherein the specified period of time ranges from about 6 to about 72 hours.

56. The method of claim 55 wherein the specified period of time ranges from about 24 to about 48 hours.

57. The method of claim 56 wherein the method additionally comprises the step of the security container distributor replacing lost, stolen or damaged security containers at no cost to the airport or seaport.

58. The method of claim 57 wherein the security container distributor replaces the lost, stolen or damaged security containers within a period of time ranging from about 1 day to about 1 week after the airport or seaport, or another individual or entity, notifies the security container distributor about such loss or damage.

59. The method of claim 56 wherein the method additionally comprises the step of the security container distributor providing 24 hours per day, 7 days per week, for 365 days per year complete support for the airport or seaport in connection with the complete operation or maintenance, or both, or all advertisements, security containers, or both.

60. A method for advertising in a security area located in, or outside of, an airport or seaport wherein a percentage of gross or net revenue generated by, or otherwise resulting from, advertising sales fees that are collected by a security container distributor from an advertiser as a result of a sale of one or more advertisements is shared by the security container distributor with the airport or seaport, comprising:
(a) providing by the security container distributor to the airport or seaport free of charge one or more security bins, security bags, or a combination thereof, wherein the security bins or security bags can contain one or more personal items of a traveler that enters into the security area, and wherein the security bins or security bags have one or more surfaces to which one or more advertisements may be affixed;
(b) collecting by the security container distributor from the advertiser of one or more advertisement sales fees in exchange for one or more opportunities by the advertiser to have one or more advertisements affixed to one or more of the surfaces of the security bins or security bags;
(c) affixing the advertisements to the surfaces of the security bins or security bags at one or more locations, and in a manner that the advertisements are visible to the public or personnel of the airport or seaport when located in the security area;
(d) placing the security bins or security bags, or both, in the security area in a manner that the security bins or security bags, or both, are visible to the public or personnel of the airport or seaport when located in the security area; and
(e) sharing by the security container distributor with the airport or seaport of a percentage of all gross or net revenue generated by, or resulting from, the advertisement sales fees, wherein the percentage ranges from about 20% to about 100%.

61. A method for advertising in a security area located in, or outside of, an airport or seaport wherein a percentage of gross or net revenue generated by, or otherwise resulting from, advertising sales fees that are collected by a security container distributor from an advertiser as a result of a sale of one or more advertisements is shared by the security container distributor with the airport or seaport, comprising:
(a) providing by the security container distributor to the airport or seaport free of charge, or with no substantial investment, one or more security bins, security bags, or a combination thereof, wherein the security bins or security bags can contain one or more personal items of a traveler that enters into the security area, and wherein the security bins or security bags have one or more surfaces to which one or more advertisements may be affixed;
(b) collecting by the security container distributor from the advertiser of one or more advertisement sales fees in exchange for one or more opportunities by the advertiser to have one or more advertisements affixed to one or more of the surfaces of the security bins or security bags;
(c) affixing the advertisements to the surfaces of the security bins or security bags at one or more locations, and in a manner that the advertisements are visible to the public or personnel of the airport or seaport when located in the security area;
(d) placing the security bins or security bags, or both, in the security area of the airport or seaport in a manner that the security bins or security bags, or both, are visible to the public or personnel of the airport or seaport when located in the security area;
(e) sharing by the security container distributor with the airport or seaport of a percentage of all gross or net revenue generated by, or resulting from, the advertisement sales fees, wherein the percentage ranges from about 10 to about 100%; and
(f) providing by the security container distributor of full operational and maintenance support in connection with the advertisements, security bins and security bags 24 hours per day, 7 days per week, 365 days per year over a period of time agreed upon between the security container distributor and the airport or seaport.
